(19) United States
(12) Patent Application Publication
(10) Pub. No.: US 2007/0153047 A1
(43) Pub. Date: Jul. 5, 2007

(54) Ink path structure, inkjet printhead having the same and method of manufacturing the inkjet printhead

(75) Inventors: Keon Kuk, Yongin-si (KR); Min-soo Kim, Seoul (KR); Bang-weon Lee, Yongin-si (KR); You-seop Lee, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/507,485

(22) Filed: Aug. 22, 2006

(30) Foreign Application Priority Data
Jan. 5, 2006 (KR) 2006-01398

(51) Int. Cl. B41J 2/015

(52) U.S. Cl. 347/20

(57) ABSTRACT

An ink path structure, an inkjet printhead having the same and a method of manufacturing the inkjet printhead includes an ink chamber in which ink to be ejected is filled, nozzles through which ink is ejected from the ink chamber, an ink feed hole through which ink is supplied to the ink chamber, a first stopper protruding from an inner wall of a path between the ink chamber and the ink feed hole, a second stopper separated from the first stopper in a direction of the ink chamber, and a moving element installed movably between the first and second stoppers to open and close the path between the ink chamber and the ink feed hole.

### CROSS-REFERENCE TO RELATED APPLICATIONS

This application claims the priority of Korean Patent Application No. 10-2006-0001398, filed on Jan. 5, 2006, in the Korean Intellectual Property Office, the disclosure of which incorporated herein in its entirety by reference.

### BACKGROUND OF THE INVENTION

1. Field of the Invention

The present general inventive concept relates to an inkjet printhead and a method of manufacturing the same, and more particularly, to an inkjet printhead having an ink path structure in which a back-flow of ink is prevented and an energy efficiency is improved and a method of manufacturing the inkjet printhead.

2. Description of the Related Art

In general, inkjet printers form an image of predetermined color by ejecting minute ink droplets from an inkjet printhead in a desired position of a printing medium. The inkjet printers include shuttle type inkjet printers which perform a printing operation by making a reciprocal motion in a direction perpendicular to a conveying direction of the printing medium, and line printing type inkjet printers which have been developed for high speed printing and include an array printhead having a size corresponding to a width of the printing medium. A plurality of inkjet printheads are arranged in a predetermined shape in the array printhead. In the line printing type inkjet printers, since the printing operation is performed when only the printing medium is conveyed in a state where the array printhead is fixed, a high speed printing can be performed.

Inkjet printheads are generally categorized into two types according to an ejection mechanism of the ink droplets. One type of inkjet printhead is a thermal inkjet printhead in which a heat source is employed to form bubbles in ink and to eject the ink due to an expansion force of the bubbles. The other type of inkjet printhead is a piezoelectric inkjet printhead in which the ink is ejected as the ink droplets by a pressure applied to the ink due to a deformation of a piezoelectric element.

FIG. 1 is a schematic plan view illustrating a conventional thermal inkjet printhead, and FIG. 2 is a cross-sectional view illustrating the conventional thermal inkjet printhead taken along a line II-II′ of FIG. 1. Referring to FIGS. 1 and 2, the conventional thermal inkjet printhead includes a substrate 10 in which an ink feed hole 12 through which ink is supplied is formed, a chamber layer 20 stacked on the substrate 10, and a nozzle layer 30 stacked on the chamber layer 20. A plurality of ink chambers 22 in which the ink to be ejected is filled and a plurality of restrictors 24 through which ink is supplied to the ink chambers 22 from the ink feed hole 12 are formed in the chamber layer 20. Nozzles 32 through which ink is ejected are formed in the nozzle layer 30. A heater 25 for generating bubbles in ink by heating ink is disposed on the bottom of each of the ink chambers 22. If a current is applied to the heater 25 in a state where ink is filled in the ink chambers 22, ink in the vicinity of the heater 25 boils and bubbles are generated. The bubbles expand continuously and apply a pressure to the ink in the ink chambers 22. As a result of the expansion of the bubbles, the ink is ejected in droplets through the nozzles 32. Next, ink is drawn into the ink chamber 22 from the ink feed hole 12 through the restrictors 24, and the ink chambers 22 are refilled with ink.

However, a back-flow of ink in which ink in the ink chambers 22 flow into the ink feed hole 12 inside the restrictors 24 when ink is ejected due to the expansion of the bubbles occurs in the inkjet printhead having the above structure. As a result, the speed at which ink is refilled in the ink chambers 22 from the ink feed hole 12 is significantly reduced. Thus, a driving frequency of the inkjet printhead is lowered. In addition, in the inkjet printhead, due to the back-flow of ink, an energy applied to the heater 25 is used to both eject ink and to flow ink in the ink chambers 22 into the ink feed hole 12. Thus, an energy efficiency of the inkjet printhead is lowered. Several ten hundreds of heaters are needed in the array printheads. Thus, the lowering of the energy efficiency is taken into account in a construction of the array printhead.

As described above, due to the ink path structure, the back-flow of ink and lowering of the energy efficiency occurs in the conventional thermal inkjet printhead. However, the problems may also occur in the piezoelectric inkjet printhead having the above-described ink path structure.

### SUMMARY OF THE INVENTION

The present general inventive concept provides an ink path structure of an inkjet printhead in which a back-flow of ink is prevented and an energy efficiency is improved.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink path structure for an inkjet printhead, the ink path structure including an ink chamber in which ink to be ejected is filled, nozzles through which the ink is ejected from the ink chamber, an ink feed hole through which ink is supplied to the ink chamber, a first stopper protruding from an inner wall of a path formed between the ink chamber and the ink feed hole, a second stopper separated from the first stopper in a direction of the ink chamber, and a moving element installed movably between the first and second stoppers to open and close the path between the ink chamber and the ink feed hole.

When ink is ejected through the nozzles, the moving element may move toward the first stopper to close the path between the ink chamber and the ink feed hole, and when ink is refilled, the moving element may move toward the second stopper to open the path between the ink chamber and the ink feed hole.

The inner wall may comprise both side walls, and the first stopper includes a plurality of first stoppers protruding from corresponding ones of the both sidewalls of the path between the ink chamber and the ink feed hole.

The second stopper may protrude from a bottom of the ink chamber.

A restrictor may be formed between the first stopper and the ink feed hole. In this case, a restrictor may be formed between the ink chamber and the ink feed hole to connect the ink chamber and the ink feedhole, and the first and second stoppers and the moving element may be disposed inside the restrictor.

The foregoing and/or other aspects and utilities of the present general inventive concept may also be achieved by providing an inkjet printhead including a substrate in which an ink feed hole through which ink is supplied is formed, a chamber layer which is provided on the substrate and in which an ink chamber in which ink to be ejected is filled is formed, and a nozzle layer provided on the chamber layer and in which nozzles through which the ink is ejected from the ink chamber are formed, a first stopper protruding from an inner wall of the chamber layer and disposed in a path between the ink chamber and the ink feed hole, a second stopper separated from the first stopper in a direction of the ink chamber, and a moving element installed movably between the first and second stoppers to open and close the path between the ink chamber and the ink feed hole.

The first and second stoppers may have a same height as that of the chamber layer and the moving element may have a height lower than that of the chamber layer. The first and second stoppers and the moving element may be formed of a same material as a material used to form the chamber layer.

The foregoing and/or other aspects and utilities of the present general inventive concept may also be achieved by providing a method of manufacturing an inkjet printhead, the method including forming a chamber material layer on a substrate, forming a chamber layer in which an ink chamber is formed, by patterning the chamber material layer and simultaneously forming a first stopper and a second stopper, forming a first sacrificial layer on the substrate, forming a moving element on the first sacrificial layer between the first and second stoppers, forming a second sacrificial layer on the first sacrificial layer to fill the chamber layer, forming a nozzle material layer on the chamber layer and the second sacrificial layer, forming nozzles through which the second sacrificial layer filled in the ink chamber is exposed, by patterning the nozzle material layer, and forming an ink feed hole through which the first sacrificial layer is exposed, by etching the substrate, and etching and removing the first and second sacrificial layers exposed through the ink feed hole and the nozzles.

The foregoing and/or other aspects and utilities of the present general inventive concept may also be achieved by providing a method of manufacturing an inkjet printhead, the method including forming an ink chamber and an ink feed hole on a substrate, forming a first stopper on one of the ink chamber and the ink feed hole, forming a second stopper in the ink chamber, and forming a moving element between the first stopper and the second stopper to close and open a path of the ink between the ink chamber and the ink feed hole.

The foregoing and/or other aspects and utilities of the present general inventive concept may also be achieved by providing an inkjet printhead, including an ink chamber, an ink feed hole to supply ink to the ink chamber, a nozzle through which the ink contained in the ink chamber is ejected, and a moveable element moveably disposed in one of the ink chamber and the ink feed hole to restrict and allow a flow of ink between the ink chamber and the ink feed hole.

The foregoing and/or other aspects and utilities of the present general inventive concept may also be achieved by providing an inkjet printhead, including a first ink chamber, a second ink chamber, an ink feed hole to supply ink to the first and second ink chambers, a first moveable element disposed in a path between the ink chamber and the ink feed hole to selectively restrict a flow of ink between the first ink chamber and the ink feed hole, and a second moveable element disposed in a second path between the second ink chamber and the ink feed hole to selectively restrict a flow of ink between the second ink chamber and the ink feed hole.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic plan view illustrating a conventional thermal inkjet printhead;

FIG. 2 is a cross-sectional view illustrating the conventional thermal inkjet printhead taken along a line II-II′ of FIG. 1;

FIG. 3 is a schematic plan view illustrating an inkjet printhead according to an embodiment of the present general inventive concept;

FIG. 4 is a cross-sectional view illustrating the inkjet printhead taken along a line IV-IV′ of FIG. 3;

FIGS. 5A and 5B are, respectively, a plan view and a cross-sectional view illustrating the inkjet printhead of FIG. 3, in a case where a moving element closes a path between an ink chamber and an ink feed hole when ink is ejected;

FIGS. 6A and 6B are, respectively, a plan view and a cross-sectional view illustrating the inkjet printhead of FIG. 3, in a case where the moving element opens the path between the ink chamber and the ink feed hole when ink is refilled;

FIG. 7 is a schematic plan view illustrating an inkjet printhead according to another embodiment of the present general inventive concept;

FIG. 8 is a schematic plan view illustrating an inkjet printhead according to another embodiment of the present general inventive concept; and

FIGS. 9 through 18B illustrate a method of manufacturing an inkjet printhead according to another embodiment of the present general inventive concept.

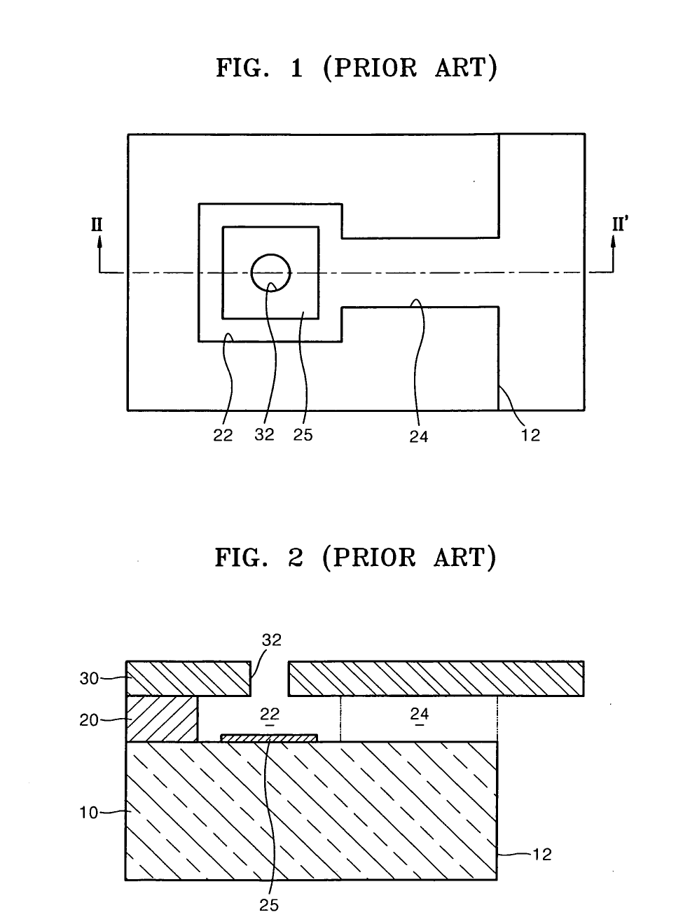

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

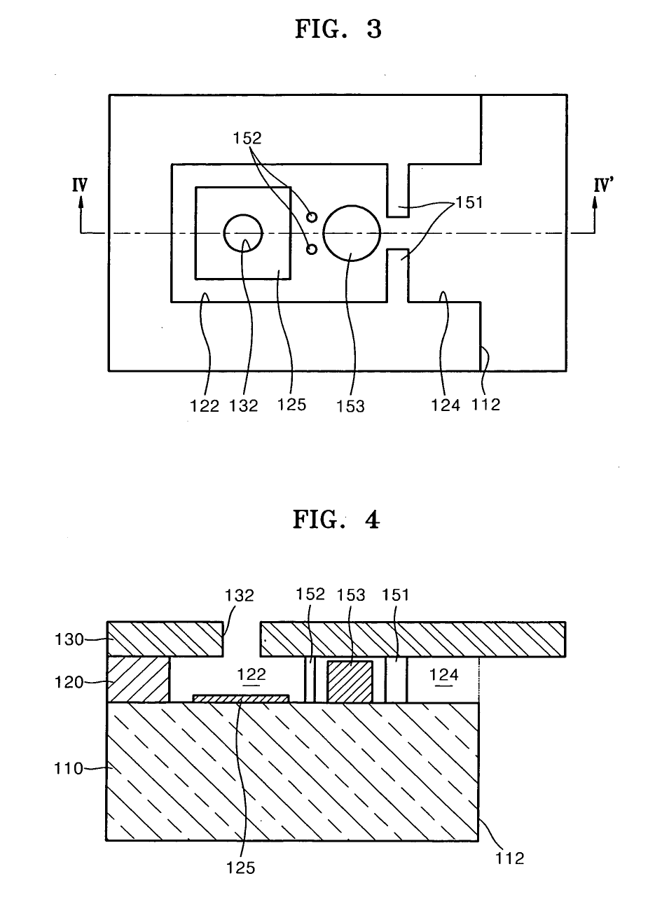

FIG. 3 is a schematic plan view illustrating an inkjet printhead according to an embodiment of the present general inventive concept, and FIG. 4 is a cross-sectional view illustrating the inkjet printhead taken along a line IV-IV′ of FIG. 3.

Referring to FIGS. 3 and 4, the inkjet printhead includes a substrate 110 in which an ink feed hole 112 is formed, a chamber layer 120 which is stacked on the substrate 110 and in which a plurality of ink chambers 122 and restrictors 124 are formed, and a nozzle layer 130 which is stacked on the chamber layer 120 and in which a plurality of nozzles 132 are formed. The substrate 110 may be formed of silicon, and the chamber layer 120 and the nozzle layer 130 may be formed of a polymer, etc.

The ink feed hole 112 perforates the substrate 110 and supplies ink to the respective ink chambers 122. The ink to be ejected through the corresponding nozzle 134 is filled in the ink chamber 122, and a heater 125 which generates bubbles in the ink by heating the ink in the ink chamber 122 is disposed on a bottom of the ink chambers 122. The restrictors 124 correspond to the ink chamber 122 and are formed in a path through which ink is supplied to the ink chamber 122 from the ink feed hole 112. The nozzles 132 communicate with the corresponding ones of the ink chambers 122, and ink in the ink chamber 122 is ejected through the corresponding nozzles 132 during an ink ejection operation.

A first stopper 151 protrudes from an inner wall of the chamber layer 120 between the ink chamber 122 and the restrictor 124. The first stopper 151 may also protrude from both sidewalls of the chamber layer 120. A second stopper 152 is separated from the first stopper 151 in a direction of the ink chambers 122. The second stopper 152 is disposed between the first stopper 151 and the heater 125. Here, the second stopper 152 may protrude from the bottom of the ink chambers 122. Two second stoppers 152 are illustrated in FIG. 3. However, one or three or more second stoppers 152 may be provided. The first and second stoppers 151 and 152 may have a same height as a height of the chamber layer 120 or the restrictor 124. The first and second stoppers 151 and 152 may be formed of a same material as a material used to form the chamber layer 120 or the restrictor 124.

A moving element 153 is installed movably between the first stopper 151 and the second stopper 152. A height of the moving element 153 may be lower than that of the chamber layer 120 or the restrictor 124 so as to allow a movement between the first stopper 151 and the second stopper 152. The moving element 153 moves between the first stopper 151 and the second stopper 152 to open and close a path between the ink chamber 122 and the restrictor 124. Specifically, the moving element 153 prevents a back-flow of the ink by closing the path between the ink chamber 122 and the restrictor 124 during the ink ejection operation and facilitates a refilling of the ink by opening the path between the ink chamber 122 and the restrictor 124 during an ink refilling operation. The moving element 153 may have a width greater than a space between the first stoppers 151 and/or greater than a second distance between the second stoppers 153. Also, the moving element 153 may have a width greater than a third distance between the first stopper 151 and the second stopper 153.

The ink feed hole 112, the restrictors 124, the ink chambers 122, the nozzles 132, the first and second stoppers 151 and 152, and the moving element 153 constitute an ink path structure of an inkjet printhead according to the present embodiment.

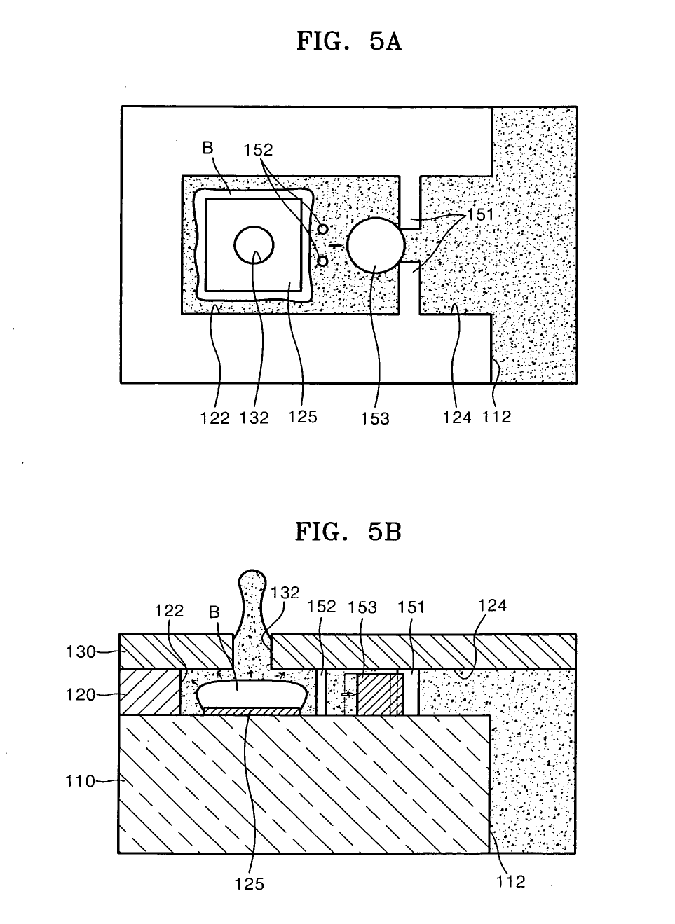

FIGS. 5A and 5B are, respectively, a plan view and a cross-sectional view illustrating the inkjet printhead of FIG. 3, in a case where the ink is ejected due to expansion of one or more bubbles B. Referring to FIGS. 5A and 5B, the bubbles B generated by the heater 125 expand during the ink ejection operation, and due to an expansion force of the bubbles B, the ink in the ink chamber 122 is pushed out toward the nozzles 132 and the restrictors 124. Because of the movement of the ink toward the restrictors 124, the moving element 153 moves toward the first stopper 151 and closes a space between the first stoppers 151. As a result, the ink path between the ink chamber 122 and the restrictor 124 is closed, and an ink flow to the ink feed hole 112 from the ink chambers 122 is not formed.

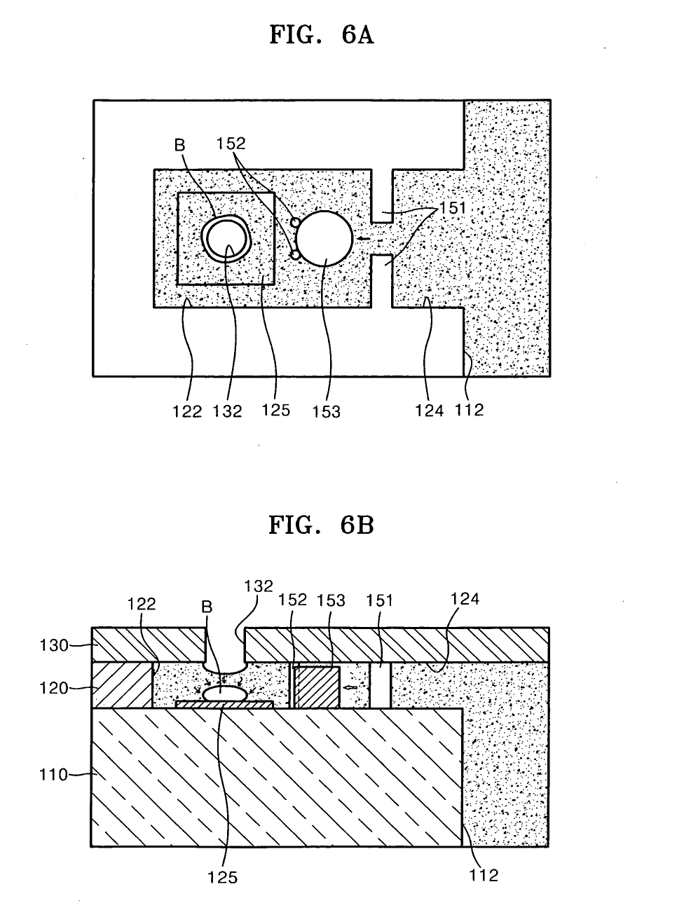

FIGS. 6A and 6B are, respectively, a plan view and a cross-sectional view illustrating the inkjet printhead of FIG. 3, in a case where the ink is refilled due to a destruction of the one or more bubbles B. Referring to FIGS. 6A and 6B, after the ink in the ink chamber 122 is ejected through the nozzles 132 and if the bubbles B are destroyed, the moving element 153 moves toward the second stopper 151 by a capillary force. The space between the first stoppers 151 is then opened so that the ink path between the ink chamber 122 and the restrictor 124 is opened. As a result, an ink flow to the ink chamber 122 from the ink feed hole 112 occurs and ink in the ink feed hole 112 is filled in the ink chamber 122 through the restrictor 124.

As described above, in the inkjet printhead of FIG. 3, the moving element 153 closes the path between the ink chamber 122 and the restrictor 124 such that the back-flow of ink in which ink in the ink chamber 122 flows to the ink feed hole 112 is prevented. In addition, during the ink refilling operation after the ink is ejected, the moving element 153 opens the path between the ink chamber 122 and the restrictor 124 such that ink in the ink feed hole 112 is easily filled in the ink chambers 122.

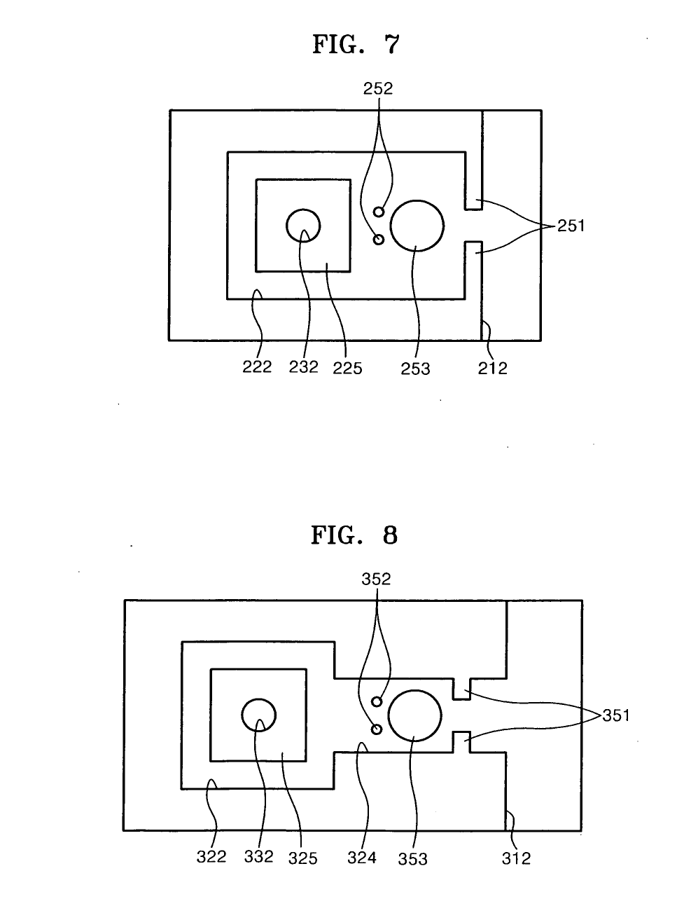

FIG. 7 is a schematic plan view illustrating an inkjet printhead according to another embodiment of the present general inventive concept. Referring to FIG. 7, an ink path structure includes an ink feed hole 212 through which ink is supplied, an ink chamber 222 in which ink to be ejected is filled, a heater 225, nozzles 232 through which ink is ejected, first and second stoppers 251 and 252, and a moving element 253. The first stopper 251 protrudes from an inner wall of a chamber layer (not shown) between the ink chamber 222 and the ink feed hole 212. The second stopper 252 is separated from the first stopper 251 in a direction of the ink chambers 222. The first stopper 251 may be in pairs, and the second stopper 252 may be in pairs. The moving element 253 is installed movably between the first stopper 251 and the second stopper 252. In the above structure, the operations in which the moving element 253 closes the path between the ink chamber 222 and the ink feed hole 212 during an ink ejection operation and opens the path between the ink chambers 222 and the ink feed hole 212 during an ink refilling operation are the same as the above-described procedure of FIGS. 3-6B and thus, a detailed description thereof will be omitted.

FIG. 8 is a schematic plan view illustrating an inkjet printhead according to another embodiment of the present general inventive concept. Referring to FIG. 8, an ink path structure includes an ink feed hole 312 through which ink is supplied, a heater 325, an ink chamber 322 in which ink to be ejected is filled, a plurality of restrictors 324 which connect the ink feed hole 312 and the ink chamber 322, nozzles 332 through which ink is ejected, first and second stoppers 351 and 352, and a moving element 353. The first and second stoppers 351 and 352 and the moving element 353 are disposed inside the restrictor 324. Specifically, the first stopper 351 protrudes from an inner wall of the restrictor 324, and the second stopper 352 is separated from the first stopper 351 in a direction of the ink chamber 322. The moving element 353 is installed movably between the first stopper 351 and the second stopper 352. Operations in which the moving element 353 closes the restrictor 324 during an ink ejection operation and opens the restrictor 324 during an ink refilling operation are the same as the above-described operations of FIGS. 3-7, and thus, a detailed description thereof will be omitted.

As described above, the ink path structure is used in the thermal inkjet printhead. However, the ink path structure may also be used in a piezoelectric inkjet printhead. The piezoelectric inkjet printhead includes an actuator having a piezoelectric element, instead of a heater.

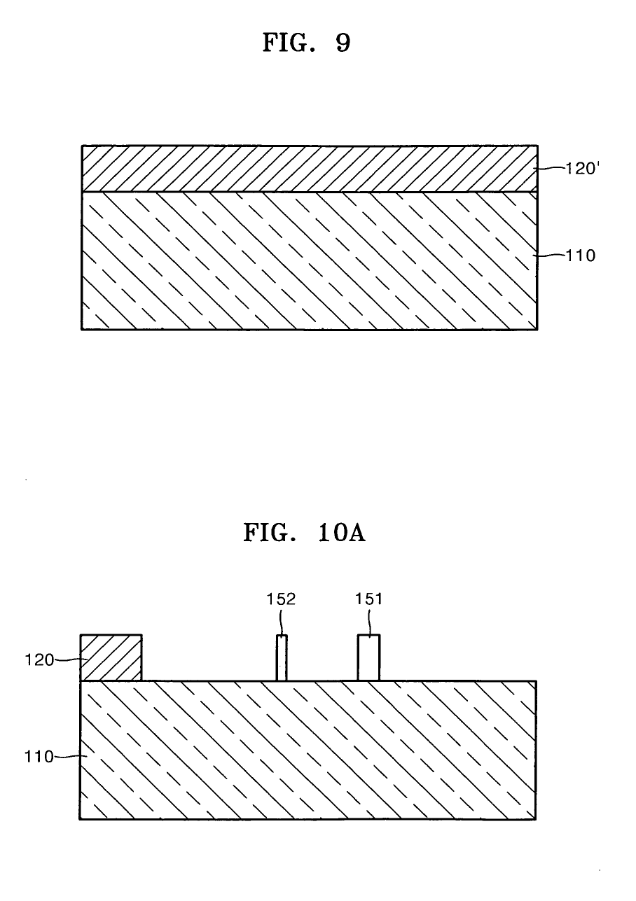

FIGS. 9 through 18B illustrate a method of manufacturing an inkjet printhead according to another embodiment of the present general inventive concept. Although FIGS. 9 through 18 illustrate the method of manufacturing the inkjet

Referring to FIG. 9, a chamber material layer 120′ is formed on a substrate 110. Material such as polymer is applied onto the substrate 110 to a predetermined thickness, thereby forming the chamber material layer 120′.

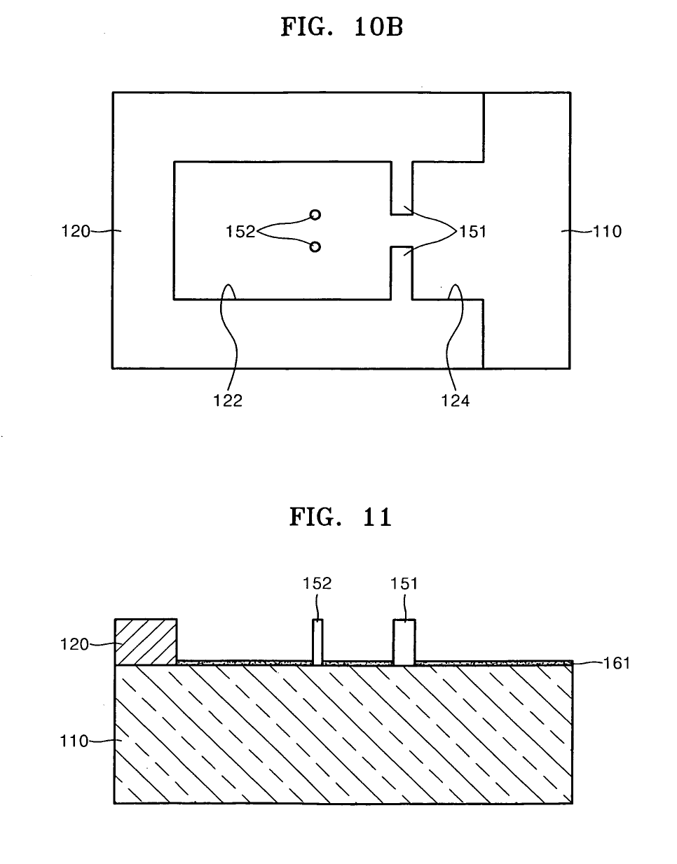

Referring to FIGS. 10A and 10B (a plan view of FIG. 10A), the chamber material layer 120′ is patterned, thereby forming a chamber layer 120 in which ink chambers 122 and restrictors 124 are formed, and simultaneously forming first and second stoppers 151 and 152. The first stopper 151 protrudes from an inner wall of the chamber layer 120 between the ink chamber 122 and the restrictor 124, and the second stopper 152 is separated from the first stopper 151 in a direction of the ink chamber 122. The first and second stoppers 151 and 152 are formed to a same height as that of the chamber layer 120.

Referring to FIG. 11, a predetermined material is applied onto the substrate 110 that forms a bottom of the ink chamber 122 and the restrictor 124, thereby forming a first sacrificial layer 161. Here, the first sacrificial layer 161 may be formed of a material having an etch selectivity with respect to the substrate 110 and the chamber layer 120.

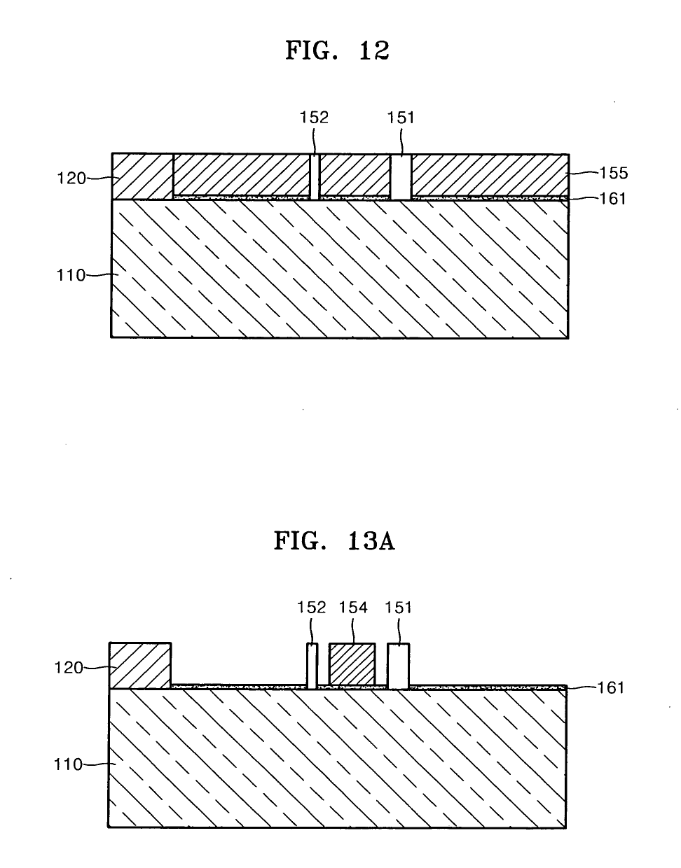

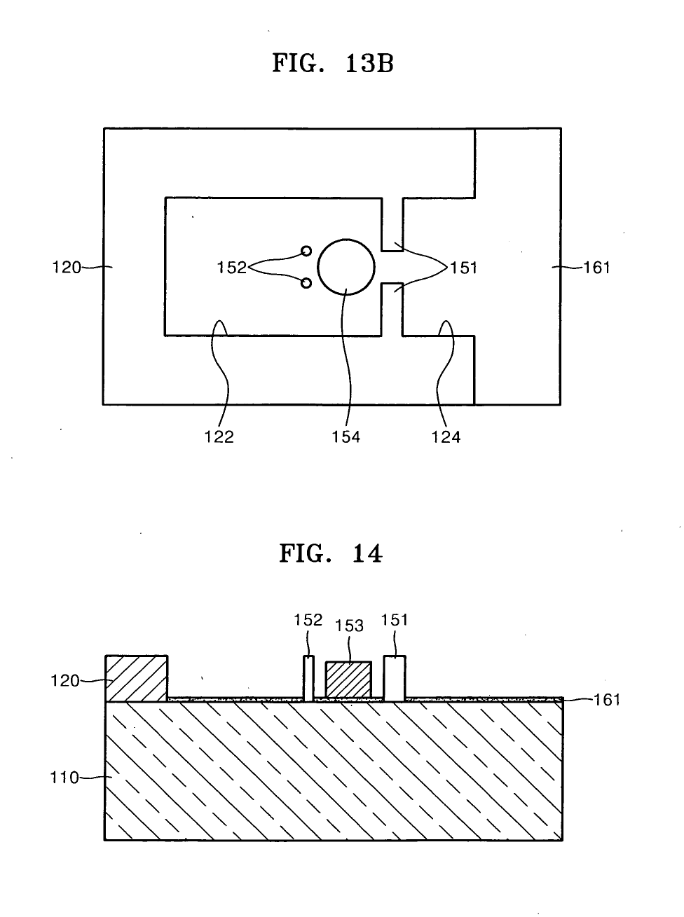

Referring to FIG. 12, a predetermined material layer 155 is formed on the first sacrificial layer 161 to fill the ink chamber 122 and the restrictor 124. The material layer 155 may be formed of the same material as a material used to form the chamber layer 120. Referring to FIGS. 13A and 13B (a plan view of FIG. 13A), the material layer 155 is patterned to form the moving element 153 which will be described later. Subsequently, referring to FIG. 14, if an upper portion of the patterned material layer 154 in FIGS. 13A and 13B is etched to a predetermined depth, the moving element 153 is formed between the first stopper 151 and the second stopper 152 to have a height lower than a height of the chamber layer 120. The moving element 153 may also be formed by forming a predetermined material layer on the first sacrificial layer 161 to a height lower than that of the chamber layer 120 and patterning the material layer.

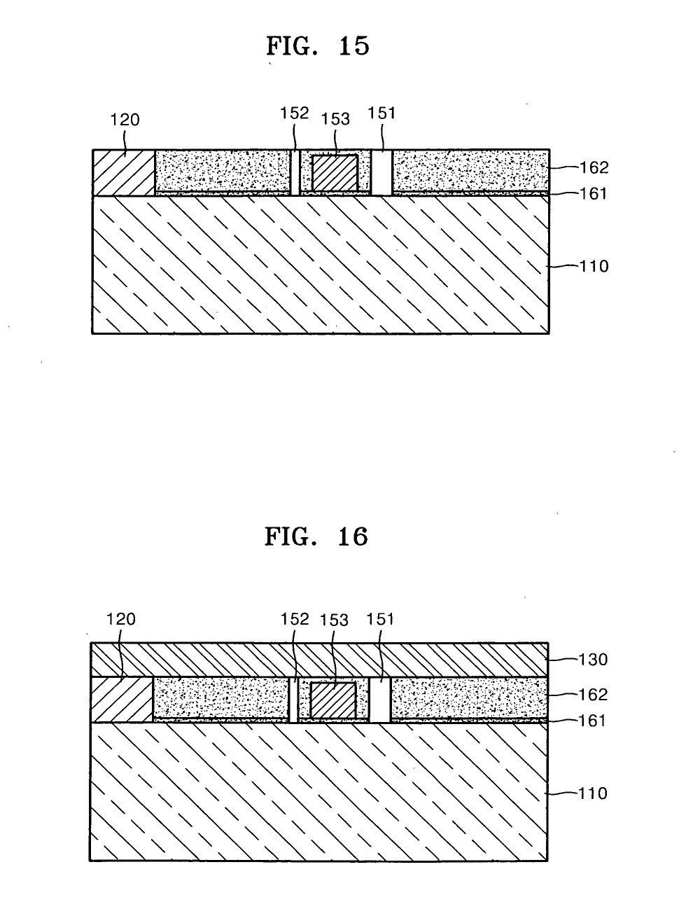

Referring to FIG. 15, a second sacrificial layer 162 is formed on the first sacrificial layer 161 and the moving element 153 so as to fill the ink chamber 122 and the restrictor 124. The second sacrificial layer 162 may be planarized so that its top surface is the same as a top surface of the chamber layer 120. Here, the second sacrificial layer 162 may be formed of a material having an etch selectivity with respect to the material used to form the substrate 110, the chamber layer 120, and a nozzle layer 130 which will be described later. The second sacrificial layer 162 may be formed of a same material as the material of the first sacrificial layer 161.

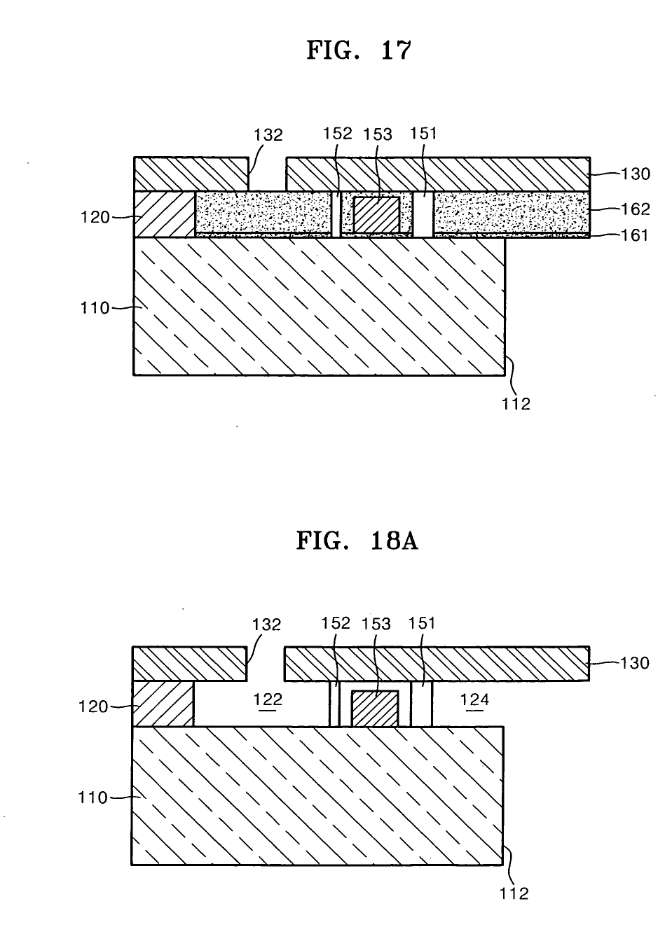

Referring to FIG. 16, a nozzle material layer 130′ is formed on top surfaces of the chamber layer 120, the second sacrificial layer 162, and the first and second stoppers 151 and 152. Here, the nozzle material layer 130′ may be formed of the same material as a material used to form the chamber layer 120. Subsequently, referring to FIG. 17, the nozzle material layer 130′ is patterned, thereby forming the nozzle layer 130 in which nozzles 132 are formed. The nozzles 132 expose the second sacrificial layer 162 filled in the ink chamber 122. An ink feed hole 112 through which the first sacrificial layer 161 is exposed is formed in the substrate 110. The ink feed hole 112 may be formed by etching a rear surface of the substrate 110 until the first sacrificial layer 161 is exposed.

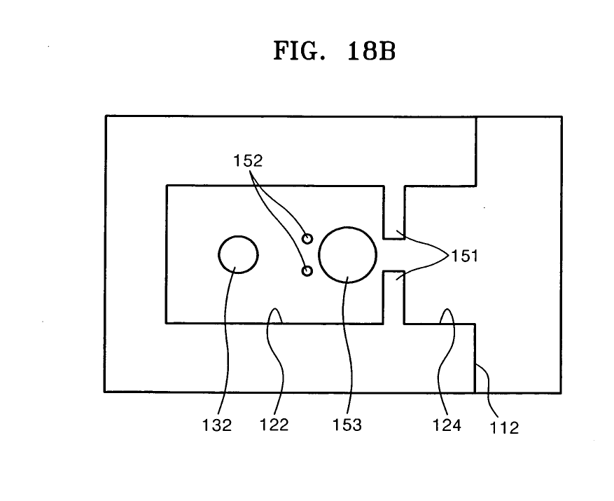

Referring to FIGS. 18A and 18B (a plan view of FIG. 18A), the fist and second sacrificial layers 161 and 162 exposed through the ink feed hole 112 and the nozzles 132 are etched and removed, thereby completing the inkjet printhead. In this operation, the ink chamber 122 and the restrictor 124 for connecting the ink chamber 122 and the ink feed hole 112 are formed in the chamber layer 120, and the moving element 153 is provided movably between the first and second stoppers 151 and 152.

As described above, the first stopper 151 is formed between the ink chamber 122 and the restrictor 124. However, as illustrated in FIG. 7, the first stopper 251 may also be formed between the ink chamber 222 and the ink feed hole 212 in a state where the restrictor 124 is not formed, and as illustrated in FIG. 8, the first and second stoppers 351 and 352 and the moving element 353 may also be formed inside the restrictor 324.

As described above, a back-flow of ink in which the ink in the ink chamber flows into the ink feed hole during the ink ejection operation can be prevented and a momentum of ejected ink droplets can be increased. A speed at which the ink is refilled in the ink chamber is increased during an ink refilling operation such that a driving frequency of an inkjet printhead is increased.

As described above, in the thermal inkjet printhead according to the present general inventive concept, due to a prevention of a back-flow of ink, a large portion of an energy applied to the heater is used to eject the ink, the energy efficiency of the heater can be improved and the size of the heater can be reduced. Similarly, in the piezoelectric inkjet printhead, a large portion of an energy applied to an actuator is used to eject the ink, and an efficiency of the actuator can be improved. As the energy efficiency is improved, an amount of an input energy required to eject the ink from the inkjet printhead can be reduced.

As described above, in a thermal inkjet printhead, since an energy applied to a heater can be reduced, a heat generated in the heater can be prevented from being accumulated in the thermal inkjet printhead.

As described above, in an array printhead having a very large number of heaters, a low power driving is necessarily required. If an ink path structure, according to the present general inventive concept, is applied to each inkjet printhead of the array printhead, a lower power driving of the array printhead can be performed, saving energy.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink path structure usable in an inkjet printhead, the ink path structure comprising:
an ink chamber in which ink is filled;
nozzles through which the ink is ejected from the ink chamber;
an ink feed hole through which ink is supplied to the ink chamber;
a first stopper protruding from an inner wall of a path formed between the ink chamber and the ink feed hole;
a second stopper separated from the first stopper in a direction of the ink chamber; and
a moving element installed movably between the first and second stoppers to open and close the path between the ink chamber and the ink feed hole.

2. The ink path structure of claim 1, wherein,
when ink is ejected through the nozzles, the moving element moves toward the first stopper to close the path between the ink chamber and the ink feed hole; and
when ink is refilled, the moving element moves toward the second stopper to open the path between the ink chamber and the ink feed hole.

3. The ink path structure of claim 1, wherein the inner wall comprises both side walls, and the first stopper comprises a plurality of first stoppers protruding from corresponding ones of the both sidewalls of the path between the ink chamber and the ink feed hole.

4. The ink path structure of claim 1, wherein the second stopper protrudes from a bottom of the ink chamber.

5. The ink path structure of claim 1, further comprising:
a restrictor formed between the first stopper and the ink feed hole to connect the ink chamber and the ink feedhole.

6. The ink path structure of claim 1, further comprising:
a restrictor formed between the ink chamber and the ink feed hole to connect the ink chambers and the ink feed hole,
wherein the first and second stoppers and the moving element are disposed inside the restrictor.

7. An inkjet printhead, comprising:
a substrate in which an ink feed hole through which ink is supplied is formed;
a chamber layer which is provided on the substrate and in which an ink chamber in which ink to be ejected is filled is formed; and
a nozzle layer provided on the chamber layer and in which nozzles through which the ink is ejected from the ink chamber are formed;
a first stopper protruding from an inner wall of the chamber layer and disposed in a path between the ink chamber and the ink feed hole;
a second stopper separated from the first stopper in a direction of the ink chamber; and
a moving element installed movably between the first and second stoppers to open and close the path between the ink chamber and the ink feed hole.

8. The inkjet printhead of claim 7, wherein:
when ink is ejected through the nozzles, the moving element moves toward the first stopper to close the path between the ink chamber and the ink feed hole; and
when ink is refilled, the moving element moves toward the second stopper to open the path between the ink chamber and the ink feed hole.

9. The inkjet printhead of claim 7, wherein the inner wall comprises both sidewalls, and the first stopper comprises a plurality of first stoppers protruding from corresponding ones of the both sidewalls of the chamber layer.

10. The inkjet printhead of claim 9, wherein the second stopper protrudes from a bottom of the ink chamber.

11. The inkjet printhead of claim 7, wherein the first and second stoppers have a same height as that of the chamber layer and the moving element has a height lower than that of the chamber layer.

12. The inkjet printhead of claim 7, wherein the first and second stoppers and the moving element are formed of a same material as a material used to form the chamber layer.

13. The inkjet printhead of claim 7, further comprising:
a restrictor formed in the chamber layer and placed between the first stopper and the ink feed hole to connect the ink chamber and the ink feedhole.

14. The inkjet printhead of claim 7, further comprising:
a restrictor formed in the chamber layer and placed between the ink chamber and the ink feed hole to connect the ink chamber and the ink feedhole,
wherein the first and second stoppers and the moving element are disposed inside the restrictor.

15. A method of manufacturing an inkjet printhead, the method comprising:
forming a chamber material layer on a substrate;
forming a chamber layer in which an ink chamber is formed, by patterning the chamber material layer and simultaneously forming a first stopper and a second stopper;
forming a first sacrificial layer on the substrate;
forming a moving element on the first sacrificial layer between the first and second stoppers;
forming a second sacrificial layer on the first sacrificial layer to fill the chamber layer;
forming a nozzle material layer on the chamber layer and the second sacrificial layer;
forming nozzles through which the second sacrificial layer filled in the ink chamber is exposed, by patterning the nozzle material layer, and forming an ink feed hole through which the first sacrificial layer is exposed, by etching the substrate; and
etching and removing the first and second sacrificial layers exposed through the ink feed hole and the nozzles.

16. The method of claim 15, wherein the first stopper protrudes from an inner wall of the chamber layer between the ink chamber and the ink feed hole and the second stopper is separated from the first stopper in a direction of the ink chamber.

17. The method of claim 15, wherein the moving element is formed to a height lower than that of the chamber layer.

18. The method of claim 17, wherein the forming of the moving element comprises:
forming a predetermined material layer on the first sacrificial layer to fill the chamber layer and then patterning the material layer; and
etching an upper portion of the patterned material layer to a predetermined depth.

19. The method of claim 18, wherein the material layer is formed of a same material as a material used to form the chamber layer.

20. The method of claim 17, wherein the forming of the moving element comprises:
forming a predetermined material layer on the first sacrificial layer to a height lower than that of the chamber layer; and
patterning the material layer.

21. The method of claim 15, wherein the nozzle layer is formed of a same material as a material used to form the chamber layer.

22. The method of claim 15, wherein the first and second sacrificial layers are formed of a material having an etch selectivity with respect to materials used to form the substrate, the chamber layer, and the nozzle layer.

23. An inkjet printhead, comprising:
an ink chamber;
an ink feed hole to supply ink to the ink chamber;
a nozzle through which the ink contained in the ink chamber is ejected; and
a moveable element moveably disposed in one of the ink chamber and the ink feed hole to restrict and allow a flow of ink between the ink chamber and the ink feed hole.

24. The inkjet printhead of claim 23, further comprising:
one or more stoppers provided between the moveable element and the ink feed hole.

25. The inkjet printhead of claim 24, wherein when the ink flows toward the ink feed hole, the moveable element is pressed against the stoppers to restrict the flow of ink.

26. The inkjet printhead of claim 24, wherein the moveable element has a height lower than that of the stoppers.

27. The inkjet printhead of claim 24, wherein the stoppers are spaced apart from each other by a distance and the moveable element has a width greater than the distance.

28. The inkjet printhead of claim 23, further comprising:
one or more stoppers provided between the moveable element and the nozzle.

29. The inkjet printhead of claim 28, wherein when the ink flows toward the nozzle the moveable element moves toward the second stoppers to not block a flow of the ink.

30. The inkjet printhead of claim 23, wherein the moveable element moves toward one of the ink chamber and the ink feed hole during a printing operation.

31. The inkjet printhead of claim 23, further comprising:
an ink path formed between the ink chamber and the ink feed hole,
wherein the moveable element is moveably disposed in the ink path to close and open the path during a printing operation.

32. The inkjet printhead of claim 23, further comprising:
first and second stoppers disposed in a direction from the ink feed hole to the ink chamber, disposed in a direction from the ink feed hole to the ink chamber, wherein the moveable element moves between the first and second stoppers.
